(19) United States
(12) Patent Application Publication
(10) Pub. No.: US 2016/0192305 A1
(43) Pub. Date: Jun. 30, 2016

(54) MOBILE COMMUNICATION TERMINAL, APPLICATION PROGRAM FOR MOBILE COMMUNICATION TERMINAL, AND FRAMEWORK PROGRAM FOR MOBILE COMMUNICATION TERMINAL

(71) Applicant: BRILLIANTSERVICE CO., LTD, Kita-ku, Osaka-shi, Osaka (JP)

(72) Inventor: Akio Kondo, Minato-ku, Tokyo (JP)

(21) Appl. No.: 14/910,304

(22) PCT Filed: Aug. 8, 2013
(86) PCT No.: PCT/JP2013/004802

§ 371 Date: Feb. 5, 2016

(51) Int. Cl. H04W 56/00

(52) U.S. Cl. CPC H04W 56/001

(57) ABSTRACT

To provide a mobile communication terminal, an application program for the mobile communication terminal, and a framework program for the mobile communication terminal which are capable of achieving power saving. In the present invention, a mobile communication terminal 100 includes one or some of applications A to D which are executed every predetermined period of time, and other(s) of the applications A to D that are executed every predetermined period of time, and includes a radio resource controller 300 for adjusting the timing(s) of communication(s) of the other(s) of the applications A to D with respect to the timing(s) of the one or some of the applications A to D.

### TECHNICAL FIELD

The present invention relates to a mobile communication terminal, an application program for the mobile communication terminal, and a framework program for the mobile communication terminal.

### BACKGROUND ART

Various researches and developments have been conducted until now for mobile communication terminals. For example, Patent Literature 1 (Japanese Patent Laid-Open No. 2012-039365) discloses a base station device that secures predetermined resources, prevents interference on a peripheral base station device, and suppresses deterioration of the reception quality of downlink control data at a communication counterpart of the base station device.

The base station device described in Patent Literature 1 (Japanese Patent Laid-Open No. 2012-039365) is a base station device for forming a cell of a size different from that of a cell formed by a peripheral base station device, and for performing communication by OFDM scheme which is the same communication scheme as that of the peripheral base station device, the base station device including power adjustment means for performing a process for reducing transmission power of control data than the transmission power of the control data at the peripheral base station device, allocating means for allocating the control data to a leading symbol in every predetermined transmission period by performing an orthogonal frequency-division multiplexing process on the control data which has been processed by the power adjustment means, and for also allocating the control data allocated to the leading symbol to a predetermined number of symbols that are continuous, on the time axis, to the leading symbol, and transmission means for transmitting the control data allocated by the allocating means to the leading symbol and the predetermined number of symbols.

Patent Literature 2 (Japanese Patent Laid-Open No. 2007-104621) discloses a communication device that is synchronized with a large number of terminals.

The communication device described in Patent Literature 2 (Japanese Patent Laid-Open No. 2007-104621) is a communication device that performs communication based on a predetermined reference timing, and includes receiving means for receiving a plurality of signals from another communication device based on respective reference timings, detection means for detecting each of the reference timings of the plurality of signals received, generation means for generating a histogram of a phase difference between the predetermined reference timing and each of the reference timings of the plurality of signals detected, specifying means for specifying, based on the generated histogram, a phase difference, to another communication terminal, by which communication with a greater number of other communication terminals may be performed by changing the predetermined reference timing, and changing means for changing the predetermined reference timing based on the specified phase difference.

Patent Literature 3 (Japanese Patent Laid-Open No. 2006-60866) discloses a communication device and a communication method for accurately detecting propagation delay for each mobile station (each channel) without affecting the number of channels to be accommodated.

A communication terminal device described in Patent Literature 3 (Japanese Patent Laid-Open No. 2006-60866) includes selection means for selecting, for each unit time, a known reference code which is unique to a channel and which is specified by a base station device from a plurality of different known reference codes, and transmission means for transmitting a transmission signal having the known reference code selected by the selection means inserted for each unit time.

Patent Literature 4 (Japanese Patent Laid-Open No. 2005-294999) discloses a wireless communication system and a base station device capable of keeping excellent communication quality by preventing an instantaneous large change in interference of an uplink channel.

The base station device described in Patent Literature 4 (Japanese Patent Laid-Open No. 2005-294999) includes interference expected change amount calculation means for calculating the expected change amount of changing interference, by carrying out scheduling for communication terminal devices in the cell of the base station device, and scheduling means for carrying out scheduling such that the expected change amount of interference falls to or below a predetermined value.

### CITATION LIST

### Patent Literature

### [Patent Literature 1] Japanese Patent Laid-Open No. 2012-039365

### [Patent Literature 2] Japanese Patent Laid-Open No. 2007-104621

### [Patent Literature 3] Japanese Patent Laid-Open No. 2006-60866

### [Patent Literature 4] Japanese Patent Laid-Open No. 2005-294999

### SUMMARY OF INVENTION

### Technical Problem

However, the inventions of Patent Literatures 1 to 4 are inventions regarding a base station and a wireless communication system, and are not for saving power of a mobile communication terminal alone. Specifically, communication with the base station based solely on information such as a number specific to a mobile communication terminal.

An object of the present invention is to provide a mobile communication terminal for which power saving can be achieved, an application program for the mobile communication terminal, and a framework program for the mobile communication terminal.

### Solution to Problem

(1)

A mobile communication terminal according to one aspect includes first communication that is performed every predetermined period of time, second communication that is performed every predetermined period of time, and an adjustment unit for adjusting a timing of the second communication with respect to a timing of the first communication.

In this case, the adjustment unit may perform adjustment with respect to the first communication and the second communication that are performed every predetermined periods of time in such a way as to adjust the timing of the second communication with respect to the timing of the first communication.

Accordingly, because the timing of performance of the first communication and the timing of performance of the second communication are periodically adjusted, the number of timings the communications are performed may be reduced, and power saving may be achieved for the mobile communication terminal.

(2)

A mobile communication terminal according to a second invention may be the mobile communication terminal according to the one aspect, where the adjustment unit causes the timing of the second communication to coincide with the timing of the first communication.

In this case, because the adjustment unit causes the timing of the second communication to coincide with the timing of the first communication, power saving may be achieved for the mobile communication terminal.

(3)

A mobile communication terminal according to a third invention may be the mobile communication terminal according to the one aspect, where the adjustment unit thins out the timing of the first communication down to the timing of the second communication.

In this case, the adjustment unit may thin out the timing of the first communication down to the timing of the second communication. As a result, the first communication may be performed in accordance with the timing of the second communication, and power saving may be achieved for the mobile communication terminal.

(4)

A mobile communication terminal according to a fourth invention may be the mobile communication terminal, according any one of the one aspect, the second invention and the third invention, including a power detection unit for detecting power that is supplied, where the adjustment unit performs adjustment according to a remaining amount of power communicated from the power detection unit.

In this case, the adjustment unit may perform adjustment according to the remaining amount of power communicated from the power detection unit. As a result, the operation of the adjustment unit may be reduced if a large amount of power remains, and the operation of the adjustment unit may be increased if the amount of power is small.

As a result, the operation of the adjustment unit may be adjusted according to the situation communicated from the power detection unit.

(5)

A mobile communication terminal according to a fifth invention is the mobile communication terminal, according to any one of the one aspect, the second invention and the third invention, including a communication detection unit for detecting a communication environment, where the adjustment unit performs adjustment according to the communication environment communicated from the communication detection unit.

In this case, the adjustment unit may perform adjustment according to the communication environment communicated from the communication detection unit. As a result, the operation of the adjustment unit may be reduced if the communication environment is good, and the operation of the adjustment unit may be increased if the communication environment is poor.

As a result, the operation of the adjustment unit may be adjusted according to the situation communicated from the communication environment unit.

(6)

A mobile communication terminal according to a sixth invention is the mobile communication terminal, according to any one of the one aspect and the second to the fifth inventions, further including a recording unit for recording at least records of the first communication and the second communication, where the adjustment unit performs adjustment according to the records recorded in the recording unit.

In this case, records of the first communication and the second communication are recorded in the recording unit. Accordingly, the adjustment unit may perform adjustment according to the records recorded in the recording unit.

As a result, the adjustment unit may be operated according to the records recorded in the recording unit.

(7)

An application program, for a mobile communication terminal, according to another aspect uses the mobile communication terminal according to any one of claims 1 to 6.

In this case, according to the application program for the mobile communication terminal, the adjustment unit may perform adjustment with respect to the first communication and the second communication that are performed every predetermined periods of time in such a way as to adjust the timing of the second communication with respect to the timing of the first communication.

Accordingly, because the timing of performance of the first communication and the timing of performance of the second communication are periodically adjusted, the number of timings the communications are performed may be reduced, and power saving may be achieved for the mobile communication terminal.

(8)

A framework program, for a mobile communication terminal, according to another aspect uses the mobile communication terminal according to any one of claims 1 to 6.

In this case, according to the framework program for the mobile communication terminal, the adjustment unit may adjust, on the first communication and the second communication that are performed every predetermined periods of time, the timing of the second communication with respect to the timing of the first communication.

Accordingly, because the timing of performance of the first communication and the timing of performance of the second communication are periodically adjusted, the number of timings the communications are performed may be reduced, and power saving may be achieved for the mobile communication terminal.

### BRIEF DESCRIPTION OF DRAWINGS

FIG. 1 is a schematic diagram for describing the inside of a mobile communication terminal according to a present embodiment.

FIG. 2 is a schematic diagram showing the amount of power consumption of each functional section shown in FIG. 1.

FIG. 3 is a diagram showing details of a radio resource controller.

FIG. 4 is a schematic diagram showing an example of power consumption of the radio resource controller.

FIG. 5 is a schematic diagram showing power consumption in a communication state of the radio resource controller in a state where a communication system of the mobile communication terminal according to the present invention is not being used.

FIG. 6 is a schematic diagram showing power consumption in a communication state of the radio resource controller in a state where a communication system of the mobile communication terminal according to the present invention is used.

FIG. 7 is a schematic diagram showing a state before merging of application programs of the mobile communication terminal according to the present embodiment.

FIG. 8 is a schematic diagram showing a state where the application programs of the mobile communication terminal according to the present embodiment are merged.

FIG. 9 is a schematic diagram showing an example configuration of the mobile communication terminal.

### REFERENCE SIGNS LIST

100 Mobile communication terminal
300 Radio resource controller
400 Recording unit
510 Power detection unit
600 Communication detection unit
730 Application framework
740 Application
A to D Application

### DESCRIPTION OF EMBODIMENT

Hereinafter, an embodiment of the present invention will be described with reference to the appended drawings. In the following description, the same elements are denoted by the same reference sign. The names and functions thereof are also the same. Accordingly, redundant descriptions thereof will be omitted.

### (Basic Configuration of Mobile Communication Terminal)

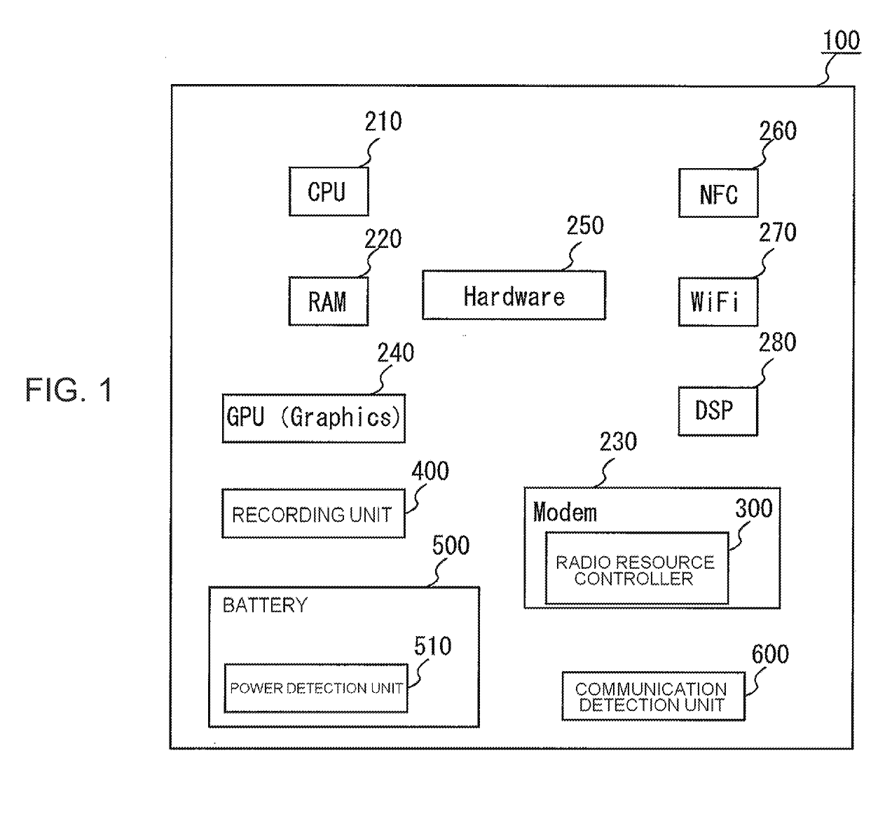

FIG. 1 is a schematic diagram for describing the inside of a mobile communication terminal 100 according to a present embodiment.

As shown in FIG. 1, the mobile communication terminal 100 mainly includes a CPU (Central Processing Unit) 210, a RAM (Random Access Memory) 220, a modem (Modulator-Demodulator) 230, a GPU (Graphics Processing Unit) 240, hardware 250, an NFC (Near Field Communication) 260, a WiFi (Wireless Fidelity) 270, a DSP (Digital Signal Processer) 280, a recording unit 400, a battery 500, and a communication detection unit 600.

Results of communication in a dormant state of the mobile communication terminal 100 are recorded in the recording unit 400 in FIG. 1.

Hereinafter, for the sake of description, the CPU 210 to the DSP 280 will be collectively referred to as each of the functional sections 210 to 280.

Furthermore, the battery 500 includes a power detection unit 510. The communication detection unit 600 detects the communication environment of the mobile communication terminal 100.

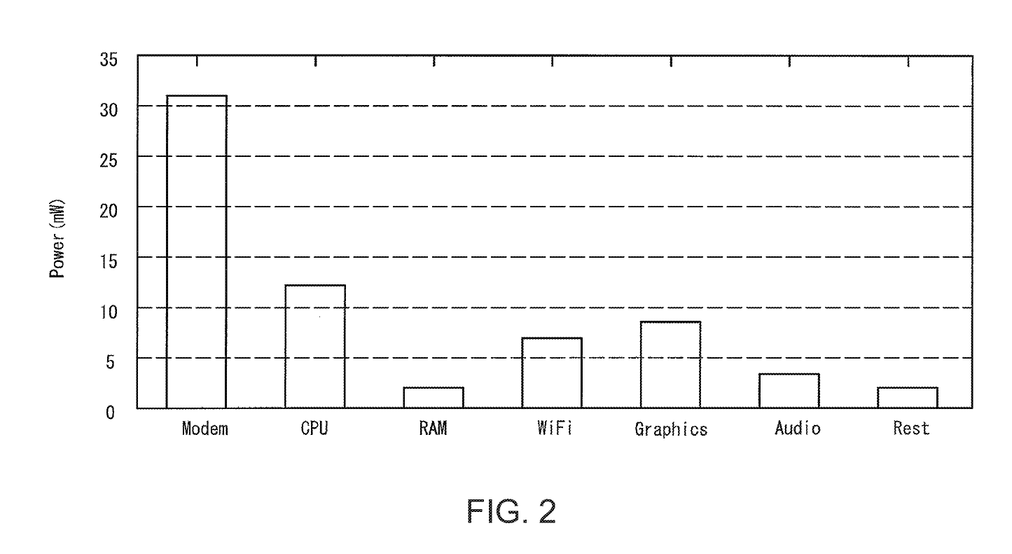

Next, FIG. 2 is a schematic diagram showing the amount of power consumption of each of the functional sections 210 to 280 shown in FIG. 1.

In the graph in FIG. 2, the vertical axis indicates the amount of power (Power (mW)), and the horizontal axis indicates each of the functional sections 210 to 280. FIG. 2 shows the amount of power consumption in a dormant state, that is, in a state where the mobile communication terminal 100 is not being used.

It can be seen from FIG. 2 that the modem 230 consumes the most power. Specifically, the modem 230 uses about 31 mW in one communication. This is about three times the amount of power consumption of the CPU 210 which uses about 13 mW.

Moreover, the modem 230 uses various communication schemes such as FDD LTE (Frequency Division Duplex Long Term Evolution), TD LTE (Time Division Long Term Evolution), CDMA (Code Division Multiple Access), WCDMA (registered trademark) (Wideband Code Division Multiple Access), TD-SCDMA (Time Division-Code Division Multiple Access), GSM (registered trademark) (Global System for Mobile Communications), and the like.

As shown in FIG. 1, the modem 230 includes a radio resource controller 300.

The modem 230 performs communication from a WAN (Wide Area Network) to an UA (User Agent) by using the radio resource controller 300.

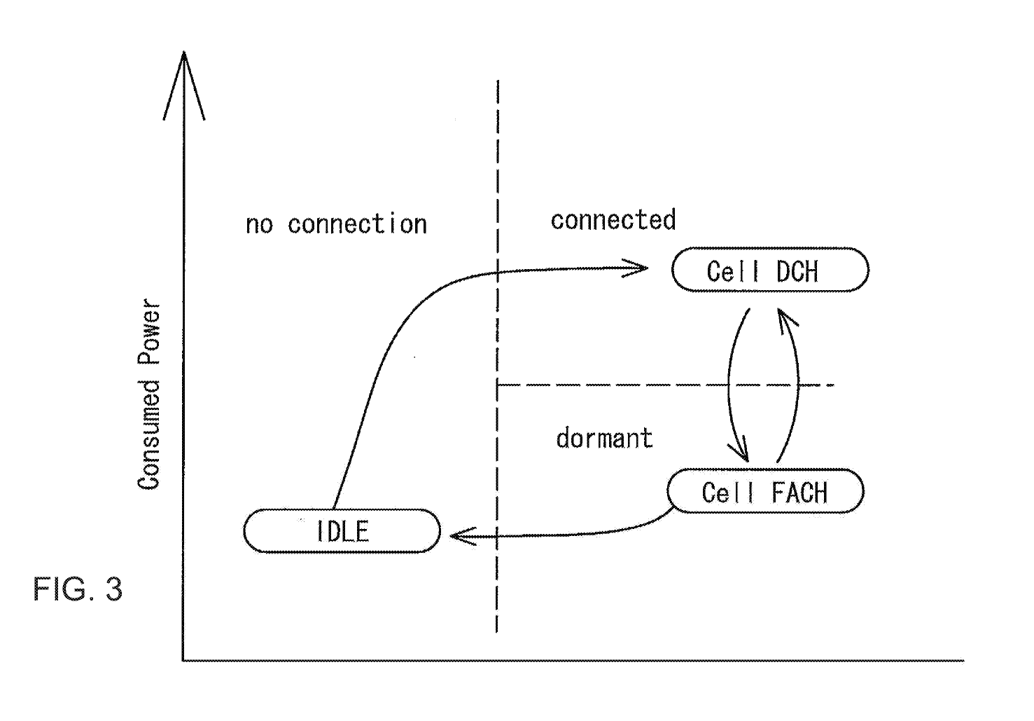

FIG. 3 is a diagram showing details of the radio resource controller 300. As shown in FIG. 3, the radio resource controller 300 includes three states: a no connection state, a connected state, and a dormant state.

As shown in FIG. 3, the radio resource controller 300 shifts from the no connection state to the connected state in two seconds, shifts from the connected state to the dormant state in five seconds, shifts from the dormant state to the connected state in five seconds, and shifts from the dormant state to the no connection state in twelve seconds.

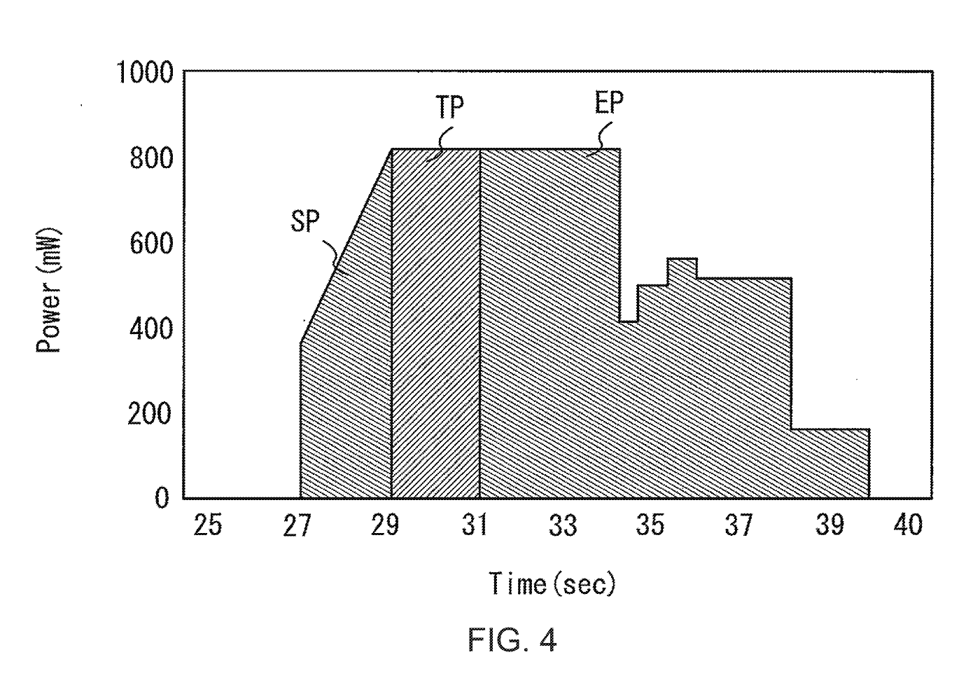

FIG. 4 is a schematic diagram showing an example of power consumption of the radio resource controller 300.

As shown in FIG. 4, the radio resource controller 300 consumes power in the first two seconds, consumes power for data transformation, and then consumes a large amount of power.

In the following, the mobile communication terminal 100, which is capable of reducing the number of times the radio resource controller 300 is used, will be described. Additionally, it is desirable not only to reduce the number of times the radio resource controller 300 is used, but also to maintain the idle state of each of the functional sections 210 to 280 and to effectively use the state of the radio resource controller 300, to avoid unnecessary communication.

### (Description of Communication Control System)

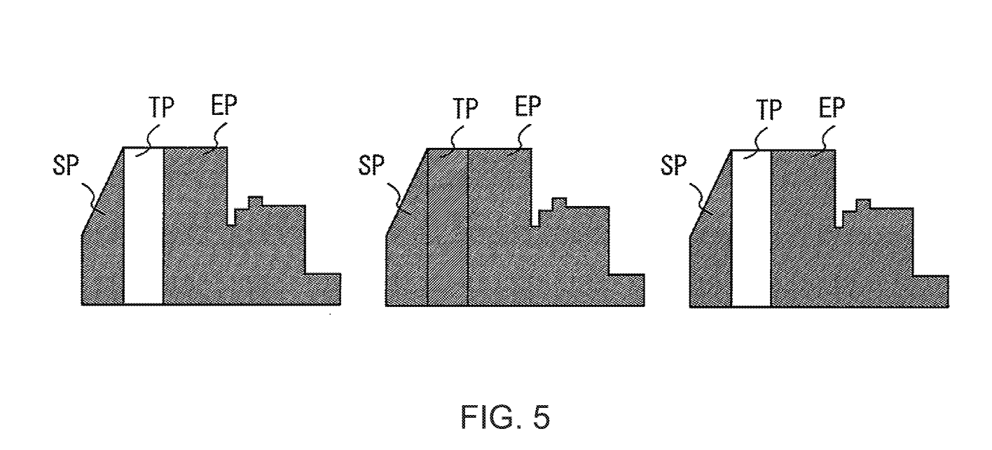

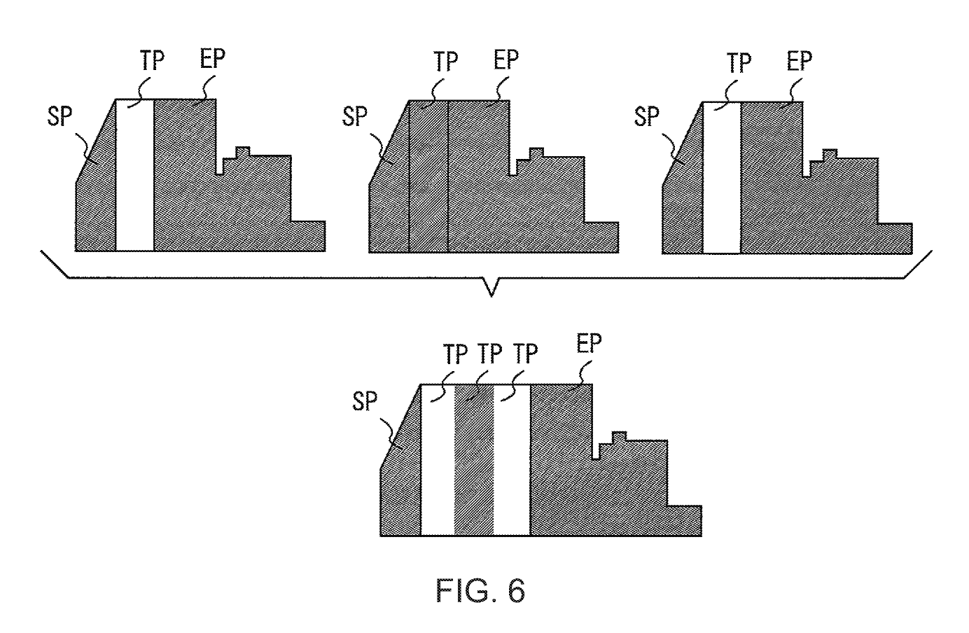

Now, FIG. 5 is a schematic diagram showing power consumption in a communication state of the radio resource controller 300 in a state where a communication system of the mobile communication terminal 100 according to the present invention is not being used, and FIG. 6 is a schematic diagram showing power consumption in a communication state of the radio resource controller 300 in a state where the communication system of the mobile communication terminal 100 according to the present invention is used.

In the present embodiment, control is performed according to record information recorded in the recording unit 400 so as to reduce the number of times the radio resource controller 300 of the modem 230 is used.

As shown in FIG. 5, in the case where the communication system of the mobile communication terminal 100 is not used, the radio resource controller 300 consumes, in one communication, consumption power SP for activation, consumption power TP for data transformation, and consumption power EP for deactivation. As a result, a large amount of consumption power (SP+TP+EP) is consumed in one communication. For example, the radio resource controller 300 in FIG. 5 consumes, in three communications, power amounting to 3(SP+TP+EP).

On the other hand, as shown in FIG. 6, in the case where the communication system of the mobile communication terminal 100 according to the present invention is used, the radio resource controller 300 merges three communications, and thus, in one communication, it consumes the consumption power SP for activation, consumes the consumption power TP for data transformation three times in a row, and then consumes the consumption power EP for deactivation. As a result, consumption power (SP+3TP+EP) is consumed in one communication merging three communications.

As described above, in the present embodiment, reduction by “consumption power 3(SP+TP+EP)−consumption power (SP+3TP+EP)”, that is, power consumption 2(SP+EP), is possible.

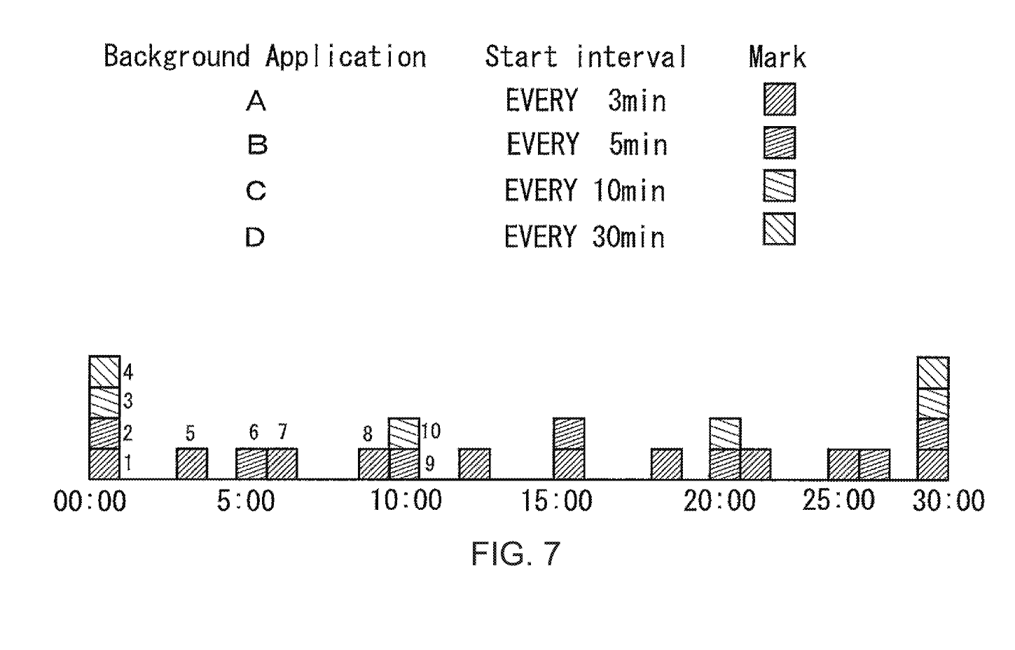

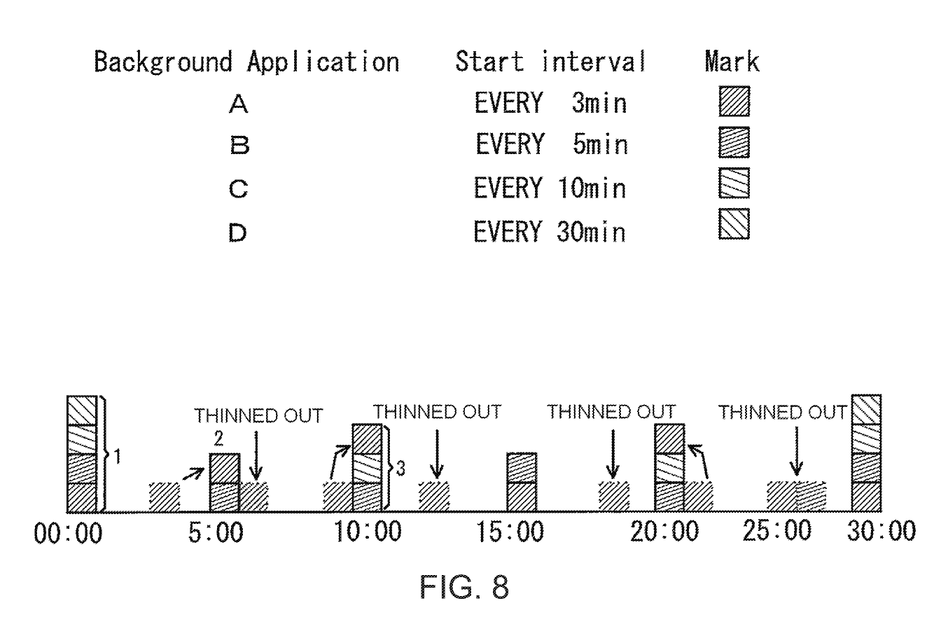

Now, FIG. 7 is a schematic diagram showing a state before merging of application programs A to D of the mobile communication terminal 100 according to the present embodiment, and FIG. 8 is a schematic diagram showing a state where the application programs A to D of the mobile communication terminal 100 according to the present embodiment are merged.

As shown in FIG. 7, there are applications A to D that operate in the background, and it is assumed that the application A performs communication every three minutes, that the application B performs communication every five minutes, that the application C performs communication every ten minutes, and that the application D performs communication every thirty minutes.

In this case, as shown in FIG. 7, all the applications A to D are started at zero minute, and the applications A to D independently start communication.

On the other hand, as shown in FIG. 8, the radio resource controller 300 of the mobile communication terminal 100 according to the present embodiment may adjust the communications performed by the applications A to D at every predetermined period of time.

For example, the communication timing of the application A may be adjusted or thinned out according to a communication record recorded in the recording unit 400 on a regular basis, and a user may perform setting regarding adjustment or thinning out of the communication timing of the application A by using application software recorded in the mobile communication terminal 100.

Also, settings regarding adjustment or thinning out of the communication timings of the applications A to D may be performed when the remaining power is low communicated from the power detection unit 510 of the battery 500, or settings regarding adjustment or thinning out of the communication timings of the applications A to D may be performed when the communication environment is poor communicated from the communication detection unit 600.

As a result, the radio resource controller 300 of the mobile communication terminal 100 according to the present embodiment may cause communications of the applications A to D performed at every predetermined period of time to be in accordance with one another.

Specifically, as shown in FIG. 8, the number of times of communication may be reduced by combining the communication of the application A that is performed three minutes past with the communication of the application B that is performed every five minutes, and by combining the communication of the application A that is performed at nine minutes past with the communication of the application C that is performed every ten minutes and the communication of the application B that is performed every five minutes. By also thinning out, that is, omitting, the communication of the application A to be performed at six minutes part, ten communications of the applications A to C performed in the background from zero minute to ten minutes (see FIG. 7) may be reduced by three communications (see FIG. 8).

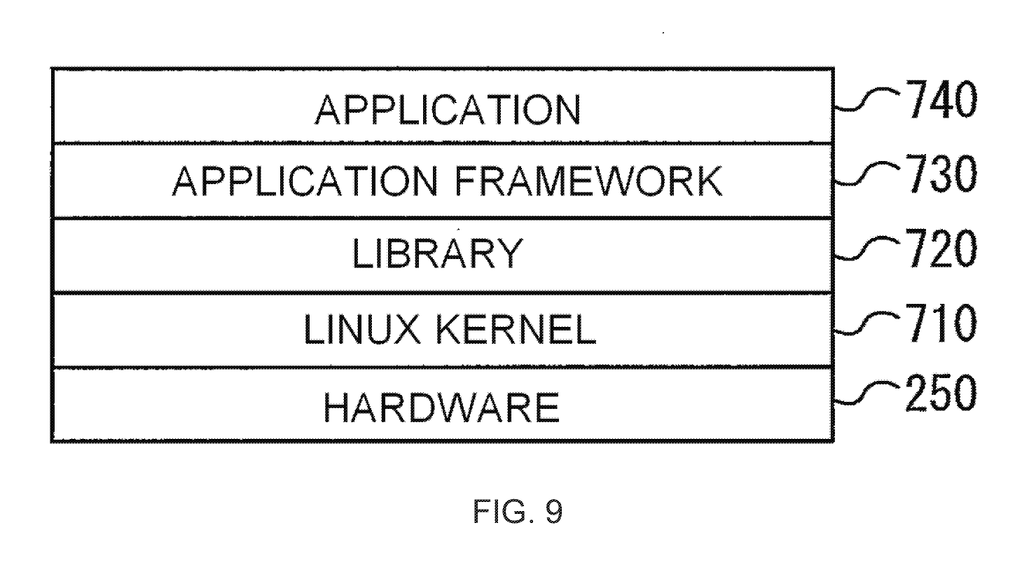

Next, FIG. 9 is a schematic diagram showing an example configuration of the mobile communication terminal 100.

As shown in FIG. 9, the configuration of the mobile communication terminal 100 includes hardware 250, a LINUX Kernel 710 (LINUX is a registered trademark), a library 720, an application framework 730, and an application 740.

The radio resource controller 300 of the mobile communication terminal 100 according to the present embodiment may adjust the communication timings of the applications A to D by the application framework 730, or the communication timings may be adjusted by the application 740.

As described above, with the communication system of the mobile communication terminal 100 according to the present embodiment, the radio resource controller 300 may perform adjustment with respect to one or some of the applications A to D that are executed every predetermined period of time and the other(s) of the applications A to D in such a way as to adjust the timing(s) of communication(s) of the other(s) of the applications A to D in relation to the one or some of the applications A to D.

Accordingly, by periodically adjusting the timings of performance of communications of the applications A to D, the number of times communication is performed may be reduced, and the power consumption of the mobile communication terminal 100 may be reduced.

Furthermore, the radio resource controller 300 may thin out one or some of the communication(s) of the applications A to D.

Moreover, the radio resource controller 300 may perform the adjustment according to the remaining amount of the battery 500 communicated from the power detection unit 510. As a result, the operation of the radio resource controller 300 may be reduced if a large amount of the battery 500 remains, and the operation of the radio resource controller 300 may be increased if the remaining amount of the battery 500 is small.

Also, the radio resource controller 300 may perform the adjustment according to the communication environment communicated from the communication detection unit 600. As a result, the operation of the radio resource controller 300 may be reduced if the communication environment is good, and the operation of the radio resource controller 300 may be increased if the communication environment is poor.

Furthermore, records of the applications A to D are recorded in the recording unit 400. Accordingly, the radio resource controller 300 may perform the adjustment according to the records recorded in the recording unit 400.

In the present invention, one or some of the applications A to D correspond to “first communication”, the other(s) of the applications A to D correspond(s) to “second communication”, the radio resource controller 300 corresponds to “adjustment unit”, the mobile communication terminal 100 corresponds to “mobile communication terminal”, the power detection unit 510 corresponds to “power detection unit”, the communication detection unit 600 corresponds to “communication detection unit”, the recording unit 400 corresponds to “recording unit”, the application 740 corresponds to “application program for mobile communication terminal”, and the application framework 730 corresponds to “framework program for mobile communication terminal”.

A preferred embodiment of the present invention has been described above, but the present invention is not limited thereto. It is to be understood that other various embodiments are possible within the spirit and the scope of the present invention. Furthermore, the operations and the effects of the configuration of the present invention have been described in the present embodiment, but the operations and the effects are only examples and are not to limit the present invention.

1. A mobile communication terminal comprising:
first communication that is performed every predetermined period of time;
second communication that is performed every predetermined period of time; and
an adjustment unit for adjusting a timing of the second communication with respect to a timing of the first communication.

2. The mobile communication terminal according to claim 1, wherein the adjustment unit causes the timing of the second communication to coincide with the timing of the first communication.

3. The mobile communication terminal according to claim 1, wherein the adjustment unit thins out the timing of the first communication down to the timing of the second communication.

4. The mobile communication terminal according to claim 1, comprising a power detection unit for detecting power that is supplied,
wherein the adjustment unit performs adjustment according to a remaining amount of power communicated from the power detection unit.

5. The mobile communication terminal according to claim 1, comprising a communication detection unit for detecting a communication environment,
wherein the adjustment unit performs adjustment according to the communication environment communicated from the communication detection unit.

6. The mobile communication terminal according to claim 1, further comprising a recording unit for recording at least records of the first communication and the second communication,
wherein the adjustment unit performs adjustment according to the records recorded in the recording unit.

7. An application program for a mobile communication terminal, wherein a mobile communication terminal according to claim 1 is used.

8. A framework program for a mobile communication terminal, wherein a mobile communication terminal according to claim 1 is used.
